(19) United States
(12) Patent Application Publication
(10) Pub. No.: US 2022/0044388 A1
(43) Pub. Date: Feb. 10, 2022

(54) METHOD FOR INTELLIGENTLY JUDGING STRAY LIGHT

(71) Applicant: HON HAI PRECISION INDUSTRY CO., LTD., New Taipei (TW)

(72) Inventors: JEN-HUNG HUANG, New Taipei (TW); CHUN-CHENG KO, New Taipei (TW)

(21) Appl. No.: 17/135,327

(22) Filed: Dec. 28, 2020

(30) Foreign Application Priority Data
Aug. 6, 2020 (CN) 202010781347.X

(51) Int. Cl. G06T 7/00; G06T 7/70; G01M 11/02

(52) U.S. Cl. CPC G06T 7/0004; G06T 2207/30168; G01M 11/0257; G06T 7/70

(57) ABSTRACT

A method for intelligently judging stray light includes obtaining pictures with stray light and an incident light angle corresponding to each of the pictures, determining a stray light judgment mechanism corresponding to each picture according to the incident light angle, determining whether each of the pictures meets an acceptance condition of the corresponding stray light judgment mechanism and obtaining a judgment result, and determining whether the product to be tested is a qualified product based on the judgment result of the pictures.

### FIELD

The subject matter herein generally relates to intelligent judgment methods, and more particularly, to a method for intelligently judging stray light.

### BACKGROUND

In the design process of the optical lens, it is necessary to measure stray light that has a visible effect on an imaging performance of the optical lens, and then adjust the structure of the optical lens or a coating of the optical lens based on a measurement result. Thus, the effect of the stray light may be minimized, and the imaging performance of the optical lens may be optimized. However, judgment standards are not uniform.

### BRIEF DESCRIPTION OF THE DRAWINGS

Implementations of the present disclosure will now be described, by way of embodiments, with reference to the attached figures.

FIG. 1 is a flowchart of a method for intelligently judging stray light according to an embodiment of the present disclosure.

FIGS. 2a, 2b, 2c, and 2d are schematic diagrams showing acceptable stray light in pictures taken at 0°, 37°-40°, 37°-40°, and 42°-53°, respectively.

FIGS. 2a′, 2b′, 2c′, and 2d′ are schematic diagrams showing unacceptable stray light in pictures taken at 0°, 37°-40°, 37°-40°, and 42°-53°, respectively.

FIG. 3 is a flowchart based on block S3 in FIG. 1.

FIG. 4 is a model diagram of a stray light judgment mechanism for a picture taken at a shooting angle of 0°.

FIG. 5 is a model diagram of a stray light judgment mechanism for a picture taken at a shooting angle of 37°-40°.

FIG. 6 is a model diagram of another stray light judgment mechanism for a picture taken at a shooting angle of 37°-40°.

FIG. 7 is a model diagram of a stray light judgment mechanism for a picture taken at a shooting angle of 42°-53°.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods. procedures and components have not been described in detail so as not to obscure the related relevant feature being described. The drawings are not necessarily to scale and the proportions of certain components may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

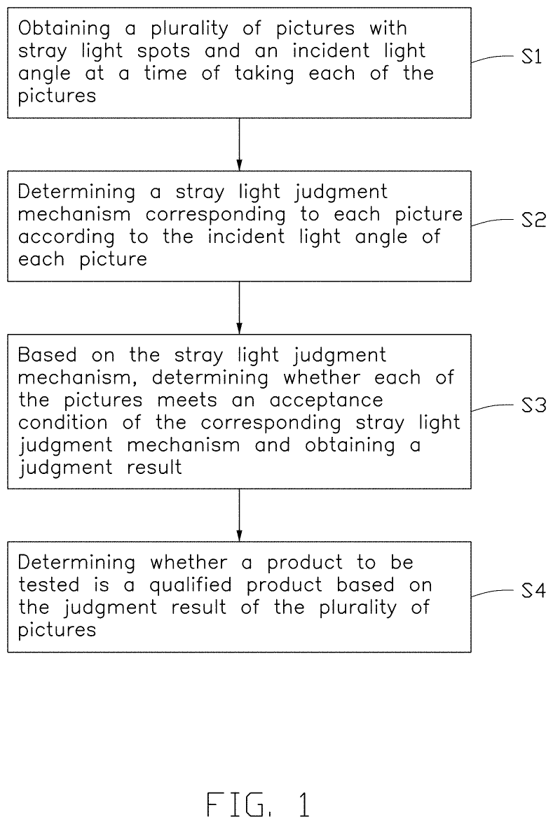

FIG. 1 shows a flowchart of a method for intelligently judging stray light according to an embodiment of the present disclosure. The method for intelligently determining stray light includes the following specific blocks.

At block S1, a plurality of pictures with stray light and an incident light angle corresponding to each of the plurality of pictures are obtained. The pictures are separately taken by a product to be tested using different components that produce the stray light at the corresponding incident light angles.

In one embodiment, the picture is taken at a specific incident light angle using a product to be tested (such as an optical lens) with different components. The components include a lens barrel, a spacer, a pressure ring, and a light shield. According to the actual use process the optical lens will have a specific stray light under a specific incident light angle for different components. According to this phenomenon, the present disclosure is based on the above four different components and verified through a large number of experiments. Each part will produce a stray light under a specific incident light angle. In order to improve a qualification rate of the products to be tested, it is necessary to judge the stray light of the pictures taken with different components to see whether the different components all meet acceptable requirements. If the different components all meet the acceptable requirements, the product to be tested is qualified. If one of the different components does not meet the acceptable requirements, the corresponding part can be improved in a targeted manner (such as adding a coating on a surface of the part) to improve a qualification rate of the product.

In order to obtain a specific incident light angle at which the stray light can be generated by the above-mentioned specific components, pictures of a large number of products to be inspected need to be taken at full angles for each part. Each shooting angle needs to be inspected to find an incident light angle where stray light occurs. The presence or absence of stray light can be easily identified through traditional judgment methods (such as human eye observation). For incident angles where the pictures have no stray light, the stray light judgment of the present disclosure is not required. Therefore, after finding the corresponding specific incident light angle at which stray light are generated for each part. the subsequent qualification judgment for the products to be tested according to the incident light angles can be performed.

In one embodiment, the incident light angle is selected from 0° to 55°. Through previous experiments, it is verified that the four components of the optical lens such as the lens barrel, the spacer, the pressure ring, and the light shield can generate specific stray light. The incident light angles are 0°, 37°-40°, and 42°-53°. For 37°-40°, pictures were taken with incident light angles of 37°, 38°, 39°, and 40°. For 42°-53°, pictures were taken with incident light angles of 42°, 43°, 44°, 45°, 46°, 47°, 48°, 49°, 50°, 51°, 52°, and 53°.

At block S2, a stray light judgment mechanism is determined corresponding to each of the plurality of pictures according to the corresponding incident light angle of the picture.

An imaging performance of pictures taken at different incident light angles may be different. Based on the pictures taken, the imaging performance of the pictures taken at different incident light angles is analyzed.

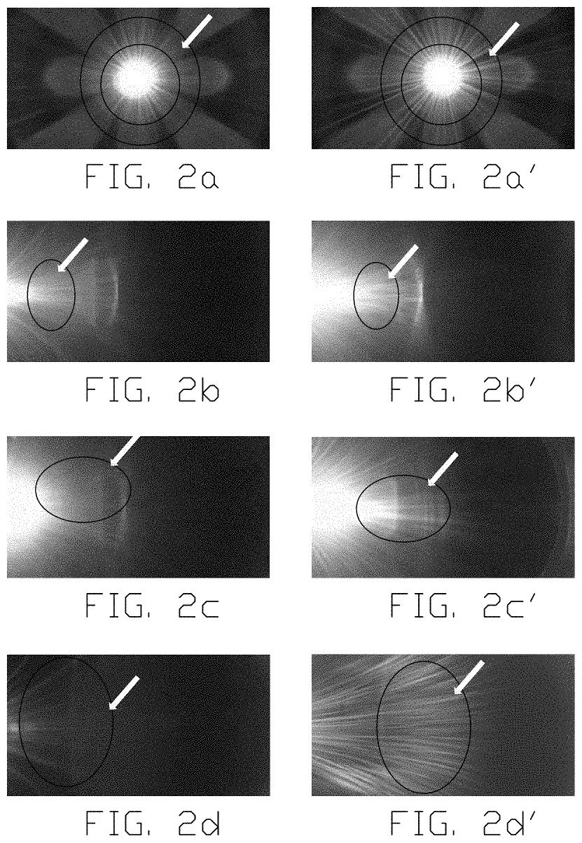

Referring to FIGS. 2a to 2d′, for each part, as the incident light angle changes, a position of a center point of a light source in the picture changes gradually from a center of the picture to a side of the picture. Taking the lens barrel as an example, at 0°, stray light appear in the picture. As can be seen from FIGS. 2a and 2a′, a center point of a light source is substantially at a center of the picture. In addition to light emitted by the light source, the picture also shows a ring-shaped spot formed by stray light, as indicated by a circled part in FIG. 2a and FIG. 2a′. There can be many types of stray light depending on the components used and the incident light angle corresponding to the picture. When using spacers and pressure rings, when the incident light angle is 37°-40°, there will be stray light in the pictures taken by the optical lens. Within this incident angle range, the center point of the light source is substantially located at a left side of the picture. Referring to FIG. 2b, FIG. 2b′, FIG. 2c, and FIG. 2c′, it can be seen that in the pictures taken by the optical lens of these two components, foggy stray light will form a certain distance from the center of the light source. However, the two types of stray light are also different. The picture taken by the optical lens when the spacer is used has a white foggy spot, as shown in FIG. 2b and FIG. 21b′. The picture taken by the optical lens when the pressure ring is used is a foggy spot with green light, as shown in FIG. 2c and FIG. 2c′. When using a light shield and the incident light angle is 42°-53°, there will be stray light in the picture taken by the optical lens. When the incident light angle is within this range, the center point of the light source is substantially on the left side edge of the picture, as can be seen in FIG. 2d and FIG. 2d′. In addition to the light emitted by the light source, the edge of the light also shows a tail-shaped spot formed by stray light, which is circled in FIG. 2d and FIG. 2d′.

There are three different stray light judgment mechanisms for the stray light generated by the above four different components. When the incident light angle is within the range of 37°-40°, the corresponding stray light judgment mechanism needs to judge two types of stray light. Therefore, it is possible to preliminarily determine which stray light judging mechanism needs to be used for judgment according to the angle range of the incident light angle at which the picture is taken.

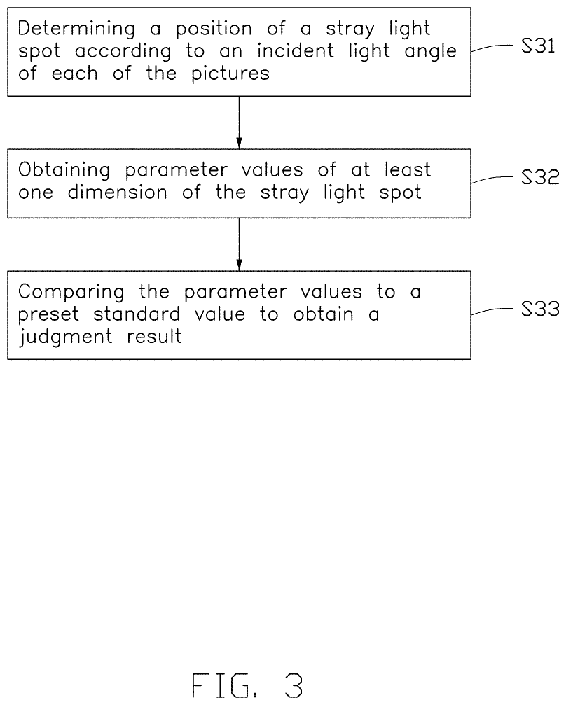

At block S3, based on the stray light judgment mechanism, whether each of the plurality of pictures meets an acceptance condition of the corresponding stray light judgment mechanism is determined, and a judgment result is obtained. As shown in FIG. 3, a method of determining whether each of the pictures meets the acceptance condition of the corresponding stray light judgment mechanism and obtaining, the judgment result includes the following blocks.

At block S31, a position of the stray light is determined according to the incident light angle of each of the pictures.

In one embodiment, when using each part according to the aforementioned determination, the appearance of stray light in the picture taken by the optical lens is related to the angle of the incident light. For a certain part, the stray light only appears within a specific range of the incident light angle, and the position of the stray light is substantially fixed. A position range of the stray light is obtained according to a large number of prior experiments, and the position range is correlated with the corresponding incident light angle. Thus, the position range is located corresponding to the incident light angle of each picture.

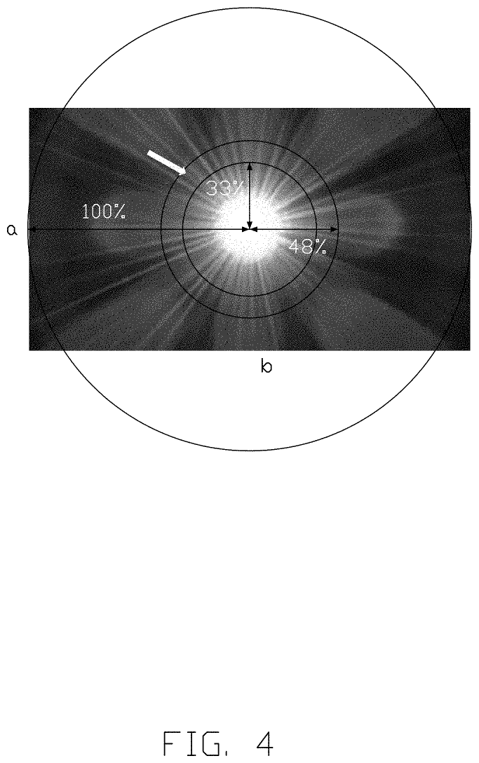

In one embodiment, shapes of the pictures are all rectangular, sizes of the pictures are the same, and a length and a width of each picture are the same. As shown in FIGS. 4-7, a direction of the first side a of the picture is a vertical direction, and a direction of a second side h of the picture is a horizontal direction.

As shown in FIG. 4, when the incident light angle is 0°, the center point of the light source in the picture is located at an intersection of two diagonals of the picture. A radius is half a length of the second side b of the picture. A ring-shaped area (indicated by an arrow in FIG. 4) where the center point of the light source extends to 33% to 48% of the radius is an area where the stray light is located.

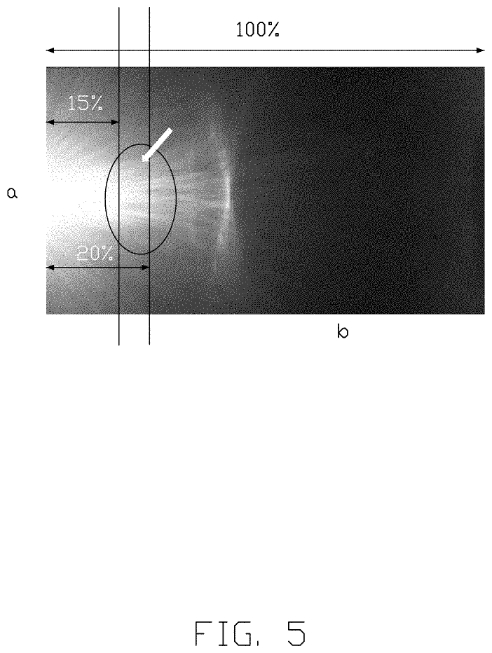

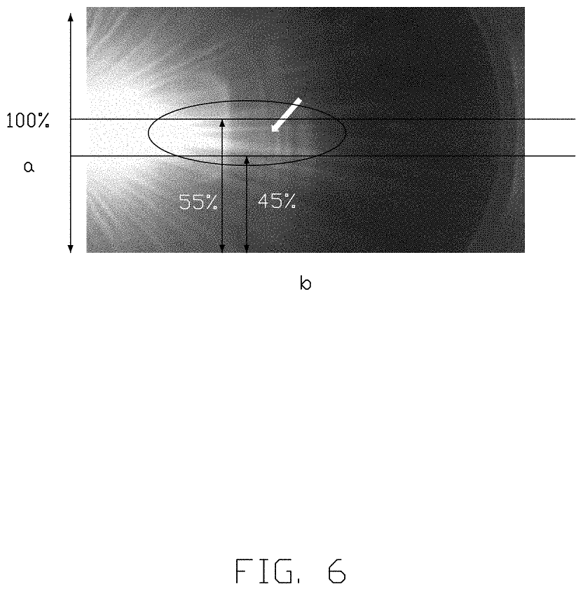

When the incident light angle is 37°-40°, there will be two types of stray light depending on the components used. As shown in FIG. 5, the center point of the light source in the picture is located at a midpoint of the first side a. A section of the picture extending 15% to 20% in the direction of the second side b from the side of the picture where the center point of the light source is located is a first section where one type of stray light is located (the area indicated by the arrow in FIG. 5). As shown in FIG. 6, the center point of the light source in the picture is located at a midpoint of the first side a. A section of the picture extending 45% to 55% in the direction of the first side a from the second side b is a second section where another type of stray light is located (the area indicated by the arrow in FIG. 6).

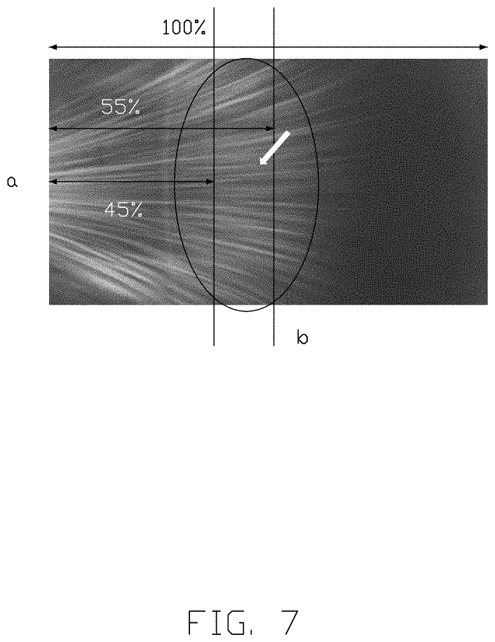

As shown in FIG. 7, when the incident light angle is 42°-53°, the center point of the light source in the picture is located at a midpoint of the first side a. A section of the picture extending 45% to 55% in the direction of the side b from the side a is a third section where one type of stray light is located (the area indicated by the arrow in FIG. 7).

At block S32, parameter values of at least one dimension of the stray light are obtained.

In one embodiment, for the above four types of stray light, the obtained parameter values are different. When the incident light angle is 0°, it is necessary to obtain a peak-to-valley value of a light intensity of the ring area. The peak-to-valley value is obtained by obtaining a light intensity peak value and a light intensity valley value in the above 33% to 48% ring area, then the light intensity peak-to-valley value is equal to the difference between the light intensity peak value and the light intensity valley value. The light intensity peak-to-valley value is a parameter value that needs to be obtained in the first stray light judgment mechanism. When the incident light angle is 37°-40°, it is necessary to obtain a total number of pixels with a pixel value greater than 200 in the first section, obtain a total number of pixels in the first section, and then determine a ratio of the pixels in the first section with a pixel value greater than 200. The ratio is a parameter value that needs to be obtained in the second stray light judgment mechanism. In addition, when the incident light angle is 37°-40°, it is also necessary to obtain pixel values of the green light in the second section and select a maximum pixel value among them as a parameter value for judgment. When the incident light angle is 42°-53°, a peak-to-valley value of the light intensity in the third section needs to be obtained, where the peak-to-valley value of the light intensity is equal to a difference between the peak light intensity value and the valley light intensity value.

At block S33, the parameter values are compared to a preset standard value to obtain a judgment result.

In this embodiment, when the incident light angle is 0°, the standard peak-to-valley value in the adopted stray light judgment mechanism is set to 75. When the peak-to-valley value of the ring area in the picture is greater than 75, it is determined that the stray light of the picture is unacceptable stray light. When the peak-to-valley value of the ring area in the picture is less than or equal to 75, it is determined that the stray light of the picture is acceptable stray light. The standard value is obtained through extensive model training. As shown in FIGS. 2a and 2a′, although it can be seen that the two stray light are different, the human eye cannot judge whether the stray light is acceptable or not. Through the above comparison, it is easy to determine whether the stray light is acceptable. Among them, the stray light in the circled portion in FIG. 2a is acceptable, while the stray light in the circled portion, in FIG. 2a′ is unacceptable.

In one embodiment, when the incident light angle is selected from 37°-40°, there are two standard values in the stray light judgment mechanism. A first standard value is that a ratio of the pixels in the first section having a pixel value greater than 200 is 10%. When the percentage of pixels in the first section having a pixel value greater than 200 is greater than 10%, the stray light in the picture is determined to be unacceptable stray light. When the percentage of pixels in the first section having a pixel value greater than 200 is less than or equal to 10%, the stray light in the picture is determined to be acceptable stray light. As shown in FIG. 2b the stray light in the circled portion is acceptable. As shown in FIG. 2b′, the stray light in the circled portion is unacceptable. In addition, a second standard value when the incident light angle is selected from 37°-40° is that a peak value of green pixels in the second section is 3. When the peak value of green pixels in the second section is greater than 3, it is determined that the stray light in the picture is unacceptable stray light. When the peak value of green pixels in the second section of the picture is less than or equal to 3, the stray light in the picture is determined to be acceptable stray light. As shown in FIG. 2c, the stray light in the circled portion is acceptable. As shown in FIG. 2c′, the stray light in the circled portion is unacceptable.

In one embodiment, when the incident light angle is selected from 42°-53°, the standard value in the stray light judgment mechanism is that the light intensity peak-to-valley value in the third section is set to 25. When the peak-to-valley value in the third section is greater than 25, it is determined that the stray light in the picture is unacceptable stray light. When the peak-to-valley value in the third section is less than or equal to 25, it is determined that the stray light in the picture is less than or equal to 25. As shown in FIG. 2d, the stray light in the circled portion is acceptable. As shown in FIG. 2d′, the stray light in the circled portion is unacceptable.

At block S4, whether the product to be tested is a qualified product is determined based on the judgment result of the plurality of pictures.

In one embodiment, it is necessary to test whether the stray light formed by the above four different components under the corresponding specific incident light angles is acceptable. When the stray light formed by the above four components are acceptable, it is determined that the product to be tested is qualified. If the stray light of the picture is unacceptable for any one part, the product to be tested is determined to be unqualified. By judging the different types of stray light obtained by testing the four different components of the product to be tested, the accuracy of the judgment is improved, and the yield of the product is effectively improved. Each part only forms stray light under a specific incident light angle, so the detection efficiency is greatly improved. At the same time, when the stray light generated by one part is unacceptable, the part can be improved accordingly, such as by coating a surface of the part, and a detection accuracy is improved while making improvements more targeted, thereby improving product yield. Through pre-model training, the models of the above three stray light judgment mechanisms are generated into an intelligent judgment process. In the subsequent inspection process, only the picture of the product to be tested and the incident light angle value are input, and the location of the stray light in the picture can be directly correlated to the incident light angle. Then, the corresponding stray light judgment mechanism can be selected, and a judgment result can be obtained. The detection process is intelligent, the detection speed is fast, and the accuracy is high. The specific stray light which is unacceptable can be identified, so that the specific part for the product to be tested can be improved in batches, which effectively improves the product yield and reduces production costs.

An electronic device (not shown) may implement a computer program that is used to execute the blocks of the method for intelligently judging stray light. The computer program may be stored on a storage medium.

Compared with the related art, the method for intelligently judging stray light provided by the present disclosure has the following beneficial effects:

1. The method for intelligently judging stray light is based on artificial intelligence. By establishing different stray light judgment mechanisms, whether the stray light in the picture is acceptable is quickly determined by inputting the incident light angle and the picture.

2. The different components of the same product to be tested are tested according to the corresponding stray light judgment mechanism, which has a high judgment accuracy. It is easy to determine which part of the product to be tested is unacceptable. The improvement is more targeted, which is convenient for improving efficiency and product yield.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the components within the principles of the present disclosure up to, and including, the full extent established by the broad general meaning of the terms used in the claims.

What is claimed is:

1. A method for intelligently judging stray light, the method comprising:
S1: obtaining a plurality of pictures with stray light and an incident light angle corresponding to each of the plurality of pictures, the plurality of pictures being separately taken by a product to be tested using different components that produces the stray light at the corresponding incident light angles;
S2: determining a stray light judgment mechanism corresponding to each of the plurality of pictures according to the corresponding incident light angle;
S3: based on the stray light judgment mechanism, determining whether each of the plurality of pictures meets an acceptance condition of the corresponding stray light judgment mechanism and obtaining a judgment result; and
S4: determining whether the product to be tested is a qualified product based on the judgment result of each of the plurality of pictures.

2. The method for intelligently judging stray light of claim 1, wherein:
the components comprise a lens barrel, a spacer, a pressure ring, and a light shield.

3. The method for intelligently judging stray light of claim 2, wherein:
the incident light angle is selected from 0°-55°.

4. The method for intelligently judging stray light of claim 3, wherein:
the lens barrel, the spacer, the pressure ring, and the light shield generate stray light at incident light angles of 0°, 37°-40°, 37°-40°, and 42°-53°, respectively.

5. The method for intelligently judging stray light of claim 4, wherein step S3 comprises:
determining a position of the stray light according to the incident light angle of each of the plurality of pictures;
obtaining parameter values of at least one dimension of the stray light; and
comparing the parameter values to a preset standard value to obtain the judgment result.

6. The method for intelligently judging stray light of claim 5, wherein:
when the incident light angle is 0°, the stray light is located in a ring area with a center point of the picture as an origin;
when the incident light angle is 37°-40, the stray light is located in a first section of the picture parallel to a first side of the picture or in a second section perpendicular to the first side of the picture; and
when the incident light angle is 42°-53°, the stray light is located in a third section parallel to the first side of the picture.

7. The method for intelligently judging stray light of claim 6, wherein:
the parameter values comprise a peak-to-valley value of light intensity in the ring-shaped area, a ratio of pixels in the first section having a pixel value greater than 200, a maximum pixel value of green light in the second section, and a peak-to-valley value of light intensity in the third section.

8. The method for intelligently judging stray light of claim 1, wherein:
when the judgment results of the plurality of pictures of the product to be tested meet the acceptance conditions of the corresponding stray light judgment mechanism, the product to be tested is a qualified product.

9. A method for intelligently judging stray light, the method comprising:
obtaining a plurality of pictures with stray light and an incident light angle corresponding to each of the plurality of pictures;
determining a stray light judgment mechanism corresponding to each of the plurality of pictures according to the corresponding incident light angle;
based on the stray light judgment mechanism, determining whether each of the plurality of pictures meets an acceptance condition of the corresponding stray light judgment mechanism and obtaining a judgment result; and
determining whether a product to be tested is a qualified product based on the judgment result of the plurality of pictures; wherein:
the incident light angle is selected from 0°-55°.

10. The method for intelligently judging stray light of claim 9, wherein:
the pictures are separately taken by the product to be tested using different components that produce the stray light at the corresponding incident light angle.
